(19) United States
(12) Patent Application Publication
(10) Pub. No.: US 2006/0021979 A1
(43) Pub. Date: Feb. 2, 2006

(54) Detection system for detecting operative positions in a retaining device for work pieces

(75) Inventor: Luciano Migliori, Milan (IT)

Correspondence Address: YOUNG & THOMPSON, 745 SOUTH 23RD STREET, 2ND FLOOR, ARLINGTON, VA, 22202, US

(73) Assignee: UNIVER S.P.A., Milan (IT)

(21) Appl. No.: 11/194,574

(22) Filed: Aug. 2, 2005

(30) Foreign Application Priority Data
Aug. 2, 2004 (IT) MI2004001584

(51) Int. Cl. B23K 11/36

(52) U.S. Cl. 219/158

(57) ABSTRACT

A detection system for operative positions in a retaining device for work pieces, in which a retaining device comprises a movable retaining member operatively connected to drive means by a longitudinally movable thrust element; the detection system comprises an elongated member, disposed in the retaining device, for supporting a plurality of sensors for detecting the position of the thrust element, the sensors being spaced apart from one another and longitudinally aligned on the support member. The system also comprises means for selectively activating at least one of the sensors of the plurality of sensors, in relation to at least one pre-established position to be detected of the retaining member; the activating means comprise an electronic control unit operatively connected to the plurality of sensors, and preset to activate the selected detecting sensor.

### BACKGROUND OF THE INVENTION

This invention concerns a detection system for detecting operative positions in retaining devices for work pieces, particularly suitable for precisely controlling the functioning of the retaining devices.

For the purposes of this specification, the expression “retaining devices” is understood to mean, without distinction, clamping, positioning and/or centering devices for work pieces.

State of the Art

In different manufacturing fields, in particular in the automotive field, retaining devices are used for clamping, positioning and/or centering work pieces to be assembled or welded to one another.

In general, a retaining device of this type, comprises a box-shaped body for supporting a retaining member which is angularly or linearly movable, depending upon the type of device, between a first operative retaining position and a second operative rest position; the device also comprises control means, such as for example a pneumatic cylinder or a linear electric actuator, operatively connected to the retaining member, by a thrust element movable according to a longitudinal axis.

Devices of this kind are usually installed along complex assembly or processing lines for assembling or processing metal sheets or structural parts of motor vehicles; therefore, in order to correctly function, such devices require precise and perfectly controlled retaining actions, according to the work programs preset for the lines.

It is consequently necessary to accurately control the functioning of the retaining devices, by monitoring the movement of the retaining member, in particular in correspondence with the first operative retaining position and the second operative rest position, the latter being variable for example in relation to the operative requirements of the device or to handling requirements of the work pieces along the line; in this way, appropriate positioning and enabling signals are transmitted to specific control units, thereby allowing a precise control of the entire working cycle.

In order to allow the necessary position controls, different detection systems have been proposed and used, comprising detecting sensors, for example of the optical, inductive or microswitch type, supported in such a way as to detect the aforesaid operative retaining and rest positions of the retaining member.

For example, EP 803331 describes a clamping device of the aforementioned kind for clamping work pieces, comprising a position detecting system, in turn comprising an already known and previously used control cassette, removably secured to the clamping device; in this case, the control cassette is in the form of a structural section supporting a first and a second detecting sensors, which are securable in adjustable positions continuously along the same structural section.

A detection system of this kind offers the advantage of allowing an easy adjustment of the position of one or both the sensors by simply extracting the control cassette from the clamping device and appropriately positioning the sensors along the supporting structural section, in relation to the operative positions of the clamping member to be detected.

However, such sensor position adjustment involves a manual operation of a certain complexity by an operator, which implies the need to stop the production line for a prolonged period of time, in order to allow the adjustment of the numerous retaining devices disposed along the same line.

Moreover, since the detecting sensors can be continuously adjusted along the supporting structural section, there is a possibility that the operator may not correctly position the sensors, resulting in faulty operation of the clamping device.

A different solution has been proposed in EP 1 306 168, which describes a clamping device of the aforementioned kind for clamping work pieces, having a position detecting system comprising a box-shaped casing, removably secured to the clamping device, for supporting a first and a second detecting sensor; in order to enable a precise adjustment of the sensor positions, the box-shaped casing is provided with side walls having a plurality of transversal slots, suitably spaced apart from one another, designed to removably house the sensors.

Such a solution allows to position the sensors in pre-established positions defined at the design stage, in relation to the requirements of the device, thereby defining beforehand and without errors the most suitable positions for the sensors.

However, also in this case a long manual operation is required for removing the supporting box-shaped casing from the clamping device, regulating the position of the sensors, and subsequently repositioning the box-shaped casing; furthermore, there is still a possibility that an operator may erroneously insert the sensors in incorrect positions from among those available.

A further solution has been suggested in EP 1 010 993, which describes a retaining device of the aforementioned kind, having an inner seating for housing a position detecting module which comprises a support casing for supporting a first and a second optical-type detecting sensor, disposed in fixed positions.

In this case, the scope of the patent application is to propose a detecting module whereby it is possible to make reliable detections not subject to disturbances, thanks to the use of optical sensors, nevertheless not new, and a specific conformation of the retaining device close to the sensors. However, it does not deal in any way with the problem of adjusting the position of the sensors, and consequently does not offer any solution to the problem of detecting different operative retaining or rest positions of the retaining member of a retaining device.

### OBJECTS OF THE INVENTION

The main object of this invention is to provide a detection system for detecting operative positions in a device for retaining work pieces, whereby it is possible to accurately detect different operative positions of the retaining member of the device, and at the same time eliminate any manual operation aimed to modify the configuration or the sensor positioning in the same detection system.

A further object of this invention is to provide a detection system of the aforementioned kind for detecting operative positions, whereby it is possible to detect different operative positions of the retaining member, corresponding to different conditions of use or control of the retaining device, by simply operating suitable means for controlling the functioning of the same detection system, or by mere self-learning of an electronic control unit of the system.

### BRIEF DESCRIPTION OF THE INVENTION

The above can be achieved by means of a system for detecting operative positions in a retaining device for work pieces, in which the retaining device comprises a box-shaped body for supporting a movable retaining member, and drive means operatively connected to the retaining member by a thrust element movable according to a longitudinal axis, the detection system comprising:
an elongated support member for supporting sensors, the sensors being arranged to detect the position of the thrust element, said support member extending longitudinally within said box-shaped body, parallel to the axis of the thrust element; and
control means for controlling the detecting sensors,
characterised in that said detecting sensors comprise a plurality of detecting sensors spaced apart arranged from one another and aligned in the longitudinal direction on said support member, and
in that said control means comprise means for selectively activating at least one of the sensors of said plurality of sensors, in relation to at least one pre-established position to be detected of the retaining member, said activating means comprising an electronic control unit operatively connected to said plurality of sensors, and preset to activate the selected detecting sensor.

### BRIEF DESCRIPTION OF THE DRAWINGS

These and further features according to this invention, will be more clearly evident from the following description with reference to the accompanying drawings, in which:

FIG. 1 shows a first embodiment of a retaining device for work pieces, in particular a toggle-lever clamping device, having a detecting system for detecting operative positions, according to this invention;

FIG. 2 shows a second embodiment of a retaining device for work pieces, in particular a centering device having a movable rod, the device comprising a detecting system for detecting operative positions, according to this invention;

FIG. 3 shows an enlarged detail of FIG. 1, illustrating the system for detecting operative positions;

FIG. 4 shows a different embodiment for the sensors of the detecting system, in respect to the one shown in FIG. 3;

FIG. 5 shows a cross-sectional view of the retaining device of FIG. 1, along the line 5-5 of FIG. 1;

FIG. 6 shows a detail of a side view of the retaining device of FIG. 1;

FIG. 7 shows an exploded perspective view of the detecting system for detecting operative positions, according to the invention;

FIG. 8 shows a longitudinal sectional view of the detecting system shown in FIG. 7 and of the cover closing the retaining device;

FIGS. 9, 10 and 11 show the block diagrams of different embodiments for the electronic control unit of the detecting system according to the invention;

FIG. 12 shows a flow chart illustrating the functioning of the self-learning electronic control unit of FIG. 9 of the detecting system according to the invention.

### DETAILED DESCRIPTION OF THE INVENTION

The general features of this invention will be illustrated hereunder by means of several exemplificative embodiments.

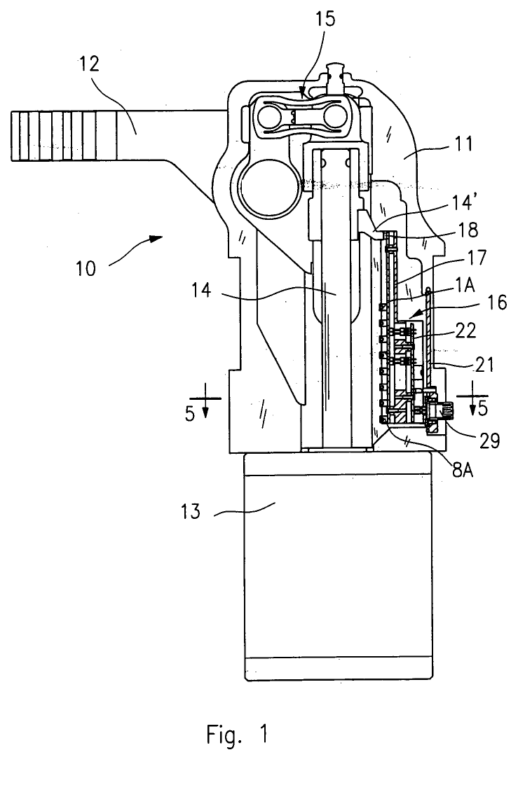

FIG. 1 shows a retaining device 10 for retaining work pieces, in the form of a toggle-lever clamping device, which comprises a box-shaped body 11 for supporting a movable retaining member, in this case a clamping arm 12 pivotally supported by the box-shaped body 11 to be angularly movable between a first operative position for retaining a work piece and a second operative rest position.

The clamping device 10 also comprises drive means 13, for example a pneumatic cylinder, an electric cylinder or other suitable linear actuator, operatively connected to the retaining member 12 by a thrust element 14, movable according to a longitudinal axis, and a per se known toggle-lever mechanism 15.

The clamping device 10 shown comprises a detection system 16 for detecting operative positions according to this invention, illustrated in greater detail in the figures from 3 to 8, which in turn comprises an elongated support member 17 for supporting a plurality of detecting sensors 18, 1A-8A, for detecting the position of the thrust element 14.

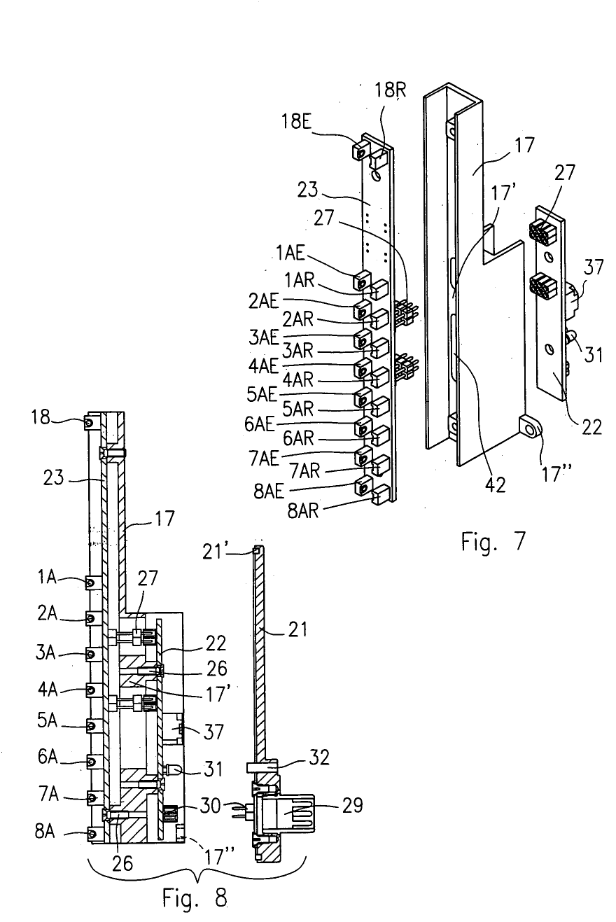

In particular, the support member 17 is secured to the box-shaped body 11, for example, as illustrated in FIGS. 6 and 7, by screws 41 which engage with the body 11 through holed side lugs 17″ of the support member 17, the support member 17 being arranged so as to longitudinally extend within the box-shaped body 11 of the device 10, parallel to the axis of the thrust element 14.

The detecting sensors 18, 1A-8A arranged on the support member 17, are spaced apart from one another and aligned in the longitudinal direction of the same support member 17, in order to allow the detection of different positions of the thrust element 14.

Preferentially, the elongated member 17 supporting the sensors 18, 1A-8A, is inserted in the box-shaped body 11 of the retaining device 10 in an inner seating 19, communicating with the outside through a side opening 20 in the box-shaped body 11, which can be tightly closed by a cover 21, removably secured to the box-shaped body 11, the cover 21 being preferentially provided with an appropriate sealing gasket 21′.

The detecting sensors 18, 1A-8A, can detect any suitable means, for example a protrusion or a tab 14′ provided on a side of the thrust element 14, in order to emit enabling signals for controlling the operation of the device.

The detecting system 16 comprises control means for controlling the detecting sensors 18, 1A-8A, in turn comprising means for activating or selectively rendering operative at least one of the sensors 18, 1A-8A, of the plurality of sensors 18, 1A-8A provided, in relation to at least one pre-established operative position to be detected of the retaining member 12.

In particular, the activating means comprise an electronic control unit 22 operatively connected to all the sensors 18, 1A-8A, which is suitably programmed and preset to activate the selected detecting sensor 18, 1A-8A.

In the case of the illustrated clamping device 10, the retaining member 12 can move between a fixed operative position for retaining or clamping a work piece, and an operative position of rest or for releasing the work piece which conversely can be varied, for example by mechanical stop devices or by a suitable programming of an electronic control unit for controlling the linear actuator, in relation to operative requirements or to the handling of work pieces along the production line in which the clamping device can be mounted.

Therefore, in this case the plurality of detecting sensors 18, 1A-8A, comprises only one detecting sensor 18 for detecting the fixed retaining position of the retaining member 12, and a plurality of detecting sensors 1A-8A for detecting the rest position of the retaining member 12, the sensors 1A-8A being selectively activated, so as to be able to accurately detect the each time preset rest position for the retaining member 12.

It cannot be excluded however that several sensors 18 can be provided for detecting the retaining position of the retaining member 12, whenever this is also variable in relation to operating requirements, and that several sensors 18 can be provided for detecting the retaining position of the retaining member 12 and only one sensor 1A for detecting the rest position of the retaining member 12.

Preferentially, the detecting sensors 18, 1A-8A are secured to an electronic anchoring card 23, which in turn is secured to the support member 17 for the sensors.

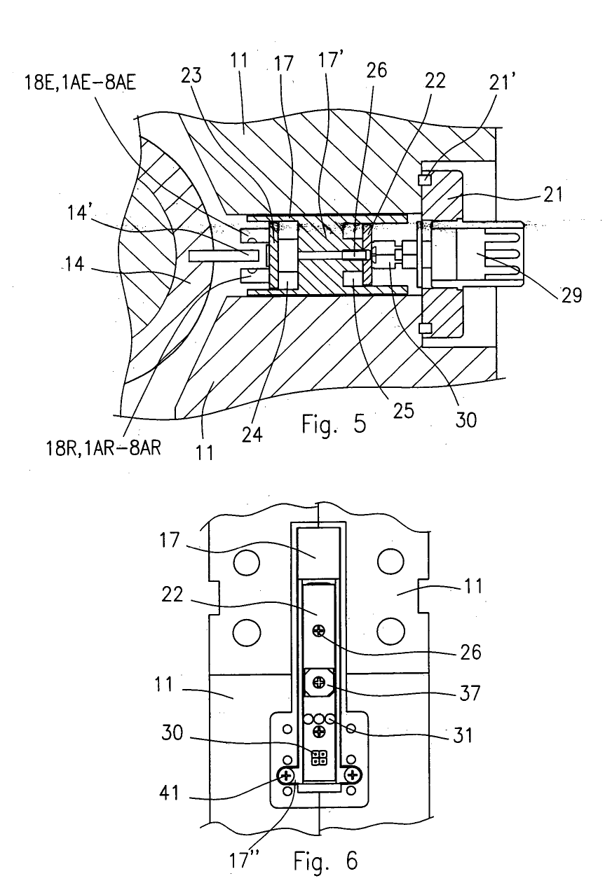

In particular, as shown in FIG. 5, the elongated support member 17 has an H-shaped cross section defining a first and a second hollow seat 24, 25 for respectively housing the electronic card 23 anchoring the sensors 18, 1A-8A and for housing the electronic control unit 22, the anchoring card 23 and the control unit 22 being secured, for example by means of screws 26, on opposing sides of a central wall 17′ of the support member 17.

The anchoring card 23 for the sensors 18, 1A-8A also forms the operative connection between the sensors 18, 1A-8A and the electronic control unit 22, by means of at least one electrical connecting element 27, shown in FIGS. 7, 8, passing through holes 42 in the central wall 17′.

Preferentially, the detecting sensors 18, 1A-8A are of the optical type, as shown in FIGS. 5 and 7, each comprising an emitting element 18E, 1AE-8AE and a receiving element 18R, 1AR-8AR secured spaced apart from each other on the electronic card 23 for anchoring the sensors 18, 1A-8A.

As an alternative, the detecting sensors 18, 1A-8A can for example be in the form of microswitches 28, as shown in FIG. 4, or of any other suitable type, or also optical sensors with a different configuration or structure.

The electronic control unit 22 is operatively connected to an external connector 29 provided on the closing cover 21, by means of a disengageable terminal 30, thereby enabling the electrical connection of the detecting system 16 with a general unit (not shown) for the management and control of the different retaining devices 10 provided along the production lines.

The electronic control unit 22 is also provided with light emitting diodes (LED) 31 designed to provide luminous indications relating to specific functional conditions of the clamping device 10, which are visible on the outside through appropriate holes 32 provided in the closing cover 21.

However, a solution without the side opening 20 in the box-shaped body 11 of the device 10, and the respective closing cover 21 is not excluded, the detecting system 16 being in this case partially accessible from the outside through appropriate holes in the box-shaped body 11, in such a way as to be able to make an operative connection of the system 16 with the aforesaid general management and control unit, and to be able to set the control unit 22 of the sensors 18, 1A-8A by means of appropriate activating means, which will be described hereunder.

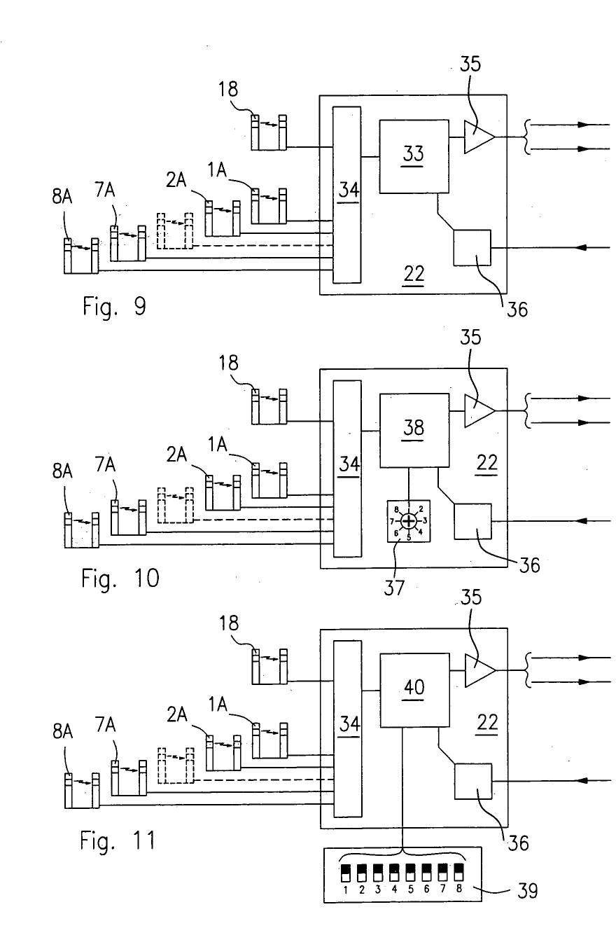

According to a first embodiment shown in FIG. 9, the electronic control unit 22 as a whole comprises a microprocessor 33 capable of self-learning the sensor to be selectively activated of the plurality of detecting sensors 1A-8A, an interface 34 for connection of the sensors 18, 1A-8A to the microprocessor 33, a buffer 35 for handling output signals from the microprocessor 33 and generating working signals for controlling the retaining device 10, and a power supply section 36 for supplying power to the control unit 22.

The self-learning microprocessor 33 in particular is programmed for selectively activating a sensor 1A-8A of the plurality of sensors 1A-8A, disposed in correspondence with a position which is acquired by means of repetition of a detection cycle, shown in FIG. 12, which detects this same position for a certain number of consecutive times.

In particular, as shown in FIG. 12, the detection by self-learning of the position of the sensor 1A-8A to be activated, comprises the steps of:
switching on the detecting system 16;
carrying out a first opening cycle of the retaining device, moving the retaining member 12 from a generic rest position to the retaining position and from there returning the retaining member 12 to the desired rest position to be set for the device;
first reading of the position of the retaining member 12 by the sensors 1A-8A, with memorisation of the position of the sensor 1A-8A which detects the rest position of the retaining member 12;
carrying out a second opening cycle of the retaining device;
reading of the position of the retaining member 12 by the sensors 1A-8A and checking that the position of the sensor 1A-8A which detects the rest position of the retaining member 12 is the same to the position detected with the first reading;
carrying out a third opening cycle of the retaining device;
reading of the position of the retaining member 12 by the sensors 1A-8A and further checking that the position of the sensor 1A-8A which detects the rest position of the retaining member 12 is the same to the position detected with the first reading;
acquiring the position of the sensor 1A-8A to be activated for detecting the preset rest position of the retaining member 12, whenever all the readings carried out coincide;
end of the detection cycle for self-learning.

In the event of a reading of the position of the retaining member 12 by the sensors 1A-8A not coinciding with the first reading carried out, the detection for self-learning re-start by repeating the first reading of the position of the retaining member 12 by the sensors 1A-8A, and then carrying out the steps described above until finding the correct position of the sensor 1A-8A capable of detecting the rest position of the retaining member 12.

In this way the selective activation of the sensor 1A-8A capable of detecting the rest position preset for the retaining member 12, takes place wholly automatically, without the need for any operation on the part of an operator.

Alternatively, as shown in FIG. 10, in which the same reference numbers have been used to illustrate similar or equivalent parts to those of FIG. 9, the electronic control unit 22 can comprise, in place of the self-learning microprocessor 33, a rotary switch 37 having a number of switching positions (1-8) corresponding to the number of sensors that can be activated (1A-BA), for selecting the sensor 1A-8A to be activated of the plurality of detecting sensors 1A-BA, and a hexadecimal decoder 38 which, in relation to the signal received from the switch 37 and the signals received from the detecting sensors 1A-8A, transmits working signals by means of a buffer 35, so as to control or ascertain that the retaining member 12 stops in correspondence with the desired rest position.

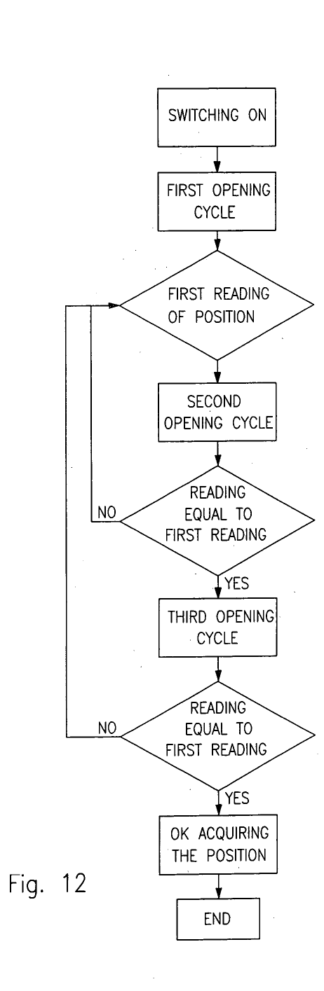

A further alternative is shown in FIG. 11, in which the same reference numbers have been used to illustrate similar or equivalent parts to those of FIG. 10; in particular, this solution is equivalent to the one shown in FIG. 10, except for the fact that the electronic control unit 22 comprises, in place of the rotary switch 37, a linear switch 39, also having a number of switching positions (1-8) corresponding to the number of sensors that can be activated (1A-8A), which allows to select the sensor 1A-8A to be activated from the plurality of detecting sensors 1A-8A, and a parallel decoder 40 which, in relation to the signal received from the switch 39 and the signals received from the detecting sensors 1A-8A, transmits working signals by means of a buffer 35, so as to control or ascertain that the retaining member 12 stops in correspondence with the desired rest position.

Contrary to what occurs for the control unit 22 shown in FIG. 9, in the cases illustrated in FIGS. 10 and 11, a simple operation is required by an operator, which consists in merely operating switches 37 or 39, after the removal of the closing cover 21 from the box-shaped body 11.

In the light of the above, it can be said with all certainty that a detecting system according to this invention allows to detect different operative positions of the retaining member of any retaining device with the utmost precision, eliminating any need for operations by an operator aimed to modifying the physical configuration or positioning of the sensors of the detecting system, and at the same time ensuring the perfect functioning of the same devices.

In this way, whenever it is necessary to modify the functioning of the retaining devices, especially in the case of variation of the operative rest position, the time required for adjusting the same devices is drastically reduced, and consequently are reduced the machine downtimes of the production lines, necessary for enabling such operations, resulting in considerable economic advantages.

Moreover, the system for detecting operative positions according to the invention allows to make detections in different operative positions of the retaining member, corresponding to different conditions of use or control of the retaining device, by simply operating suitable switches for controlling the functioning of the detecting system, or by mere self-learning of an electronic control unit of the system, with advantages in terms of simplicity of operation by the operators, thereby limiting the possibilities of error.

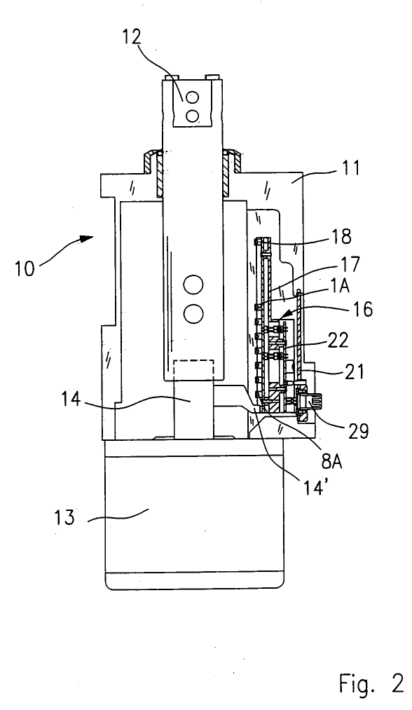

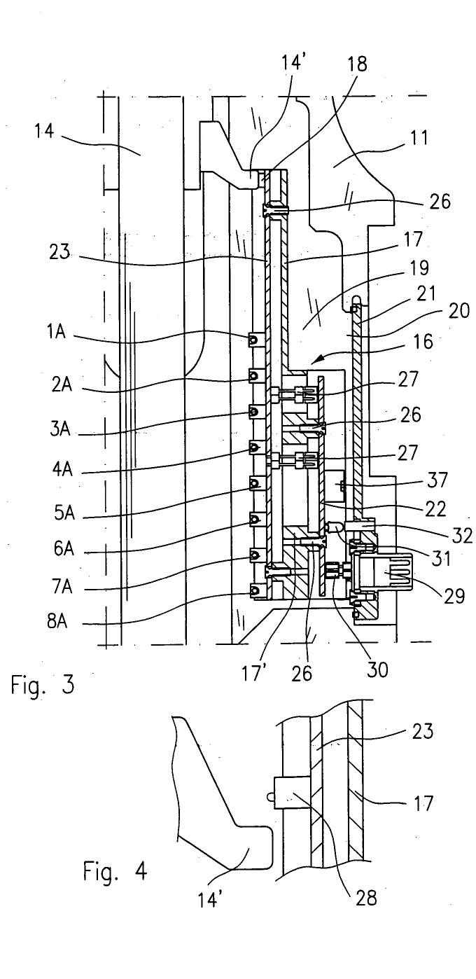

The detecting system 16 for detecting operative positions can alternatively be used in other types of retaining devices 10, for example in a centering device for work pieces as illustrated in FIG. 2, in which the same reference numbers have been used to illustrate similar or equivalent parts to those of FIG. 1.

In particular, in this case the centering device 10 comprises a retaining member 12, in the form of a centering rod, linearly movable between a forward operative position for retaining a work piece and a backward rest position for releasing the work piece, said member being operatively connected to drive means 13 by a longitudinally movable thrust element 14.

Moreover, the device 10 comprises a detecting system 16 for detecting the position of the retaining member 12 which has similar features to those already described for the previous case to which the reference is made.

What has been described and shown with reference to the accompanying drawings, has been given purely by way of example in order to illustrate the general features of the invention, as well as several of its preferential embodiments; therefore other modifications and variations to the detecting system for detecting operative positions in retaining devices for retaining work pieces are possible, without thereby deviating from the scope of the claims.

1. Detection system for detecting operative positions in a retaining device for work pieces, in which the retaining device comprises a box-shaped body for supporting a movable retaining member, and drive means operatively connected to the retaining member, by a thrust element movable according to a longitudinal axis, the detecting system comprising:
an elongated support member for supporting sensors, the sensors being arranged to detect the position of the thrust element, said support member extending longitudinally within said box-shaped body, parallel to the axis of the thrust element; and
control means for controlling the detecting sensors,
wherein said detecting sensors comprise a plurality of detecting sensors spaced apart arranged from one another and aligned in the longitudinal direction on said support member,
said control means comprising means for selectively activating at least one of the sensors of said plurality of sensors, in relation to at least one pre-established position to be detected of the retaining member, said activating means in turn comprising an electronic control unit operatively connected to said plurality of sensors, and preset to activate the selected detecting sensor.

2. Detection system according to claim 1, wherein said plurality of detecting sensors comprises a sensor for detecting the retaining position of the retaining member and a plurality of sensors for detecting the rest position of the retaining member, which can be selectively activated.

3. Detection system according to claim 1, wherein an electronic card is provided for anchoring the detecting sensors, secured to the elongated member supporting the sensors, said electronic card forming an operative connection of the detecting sensors with said electronic control unit.

4. Detection system according to claim 3, wherein said elongated member for supporting the sensors has an H-shaped cross-section defining a first and a second hollow seat for respectively housing said electronic card for anchoring the sensors and for housing said electronic control unit.

5. Detection system according to claim 3, wherein said detecting sensors are of the optical type.
Detection system according to claim 5, wherein each of said optical detecting sensors comprises an emitting element and a receiving element secured spaced apart from each other on said electronic card for anchoring the sensors.
Detection system according to claim 1, wherein said detecting sensors are microswitches.

6. Detection system according to claim 1, wherein said electronic control unit comprises a microprocessor capable of self-learning the sensor to be selectively activated from said plurality of detecting sensors.

7. Detection system according to claim 8, wherein said self-learning microprocessor is programmed for selectively activating a sensor of said plurality of sensors, disposed in correspondence with a position acquired by means of repetition of a detection cycle which detects this same position for a certain number of consecutive times.

8. Detection system according to claim 1, wherein said electronic control unit comprises a rotary switch for selecting the sensor to be activated from said plurality of detecting sensors.

9. Detection system according to claim 1, wherein said electronic control unit comprises a linear switch for selecting the sensor to be activated from said plurality of detecting sensors.

10. Detection system according to claim 1, in which said elongated member for supporting the sensors is inserted in an inner seating of the box-shaped body of the retaining device, the inner seating being in communication with the outside through a side opening in the box-shaped body, wherein a cover is provided for closing said side opening in the box-shaped body, said closing cover being removably and tightly secured to the box-shaped body of the retaining device.

13. Detection system according to claim 1, wherein said detecting sensors are of the optical type.
